(19) United States
(12) Patent Application Publication
(10) Pub. No.: US 2016/0127259 A1
(43) Pub. Date: May 5, 2016

(54) SYSTEM AND METHOD FOR MANAGING SAFE DOWNTIME OF SHARED RESOURCES WITHIN A PCD

(71) Applicant: QUALCOMM INCORPORATED, SAN DIEGO, CA (US)

(72) Inventors: CRISTIAN DUROIU, SAN DIEGO, CA (US); VINOD CHAMARTY, SAN DIEGO, CA (US); SERAG GADELRAB, ONTARIO (CA); MICHAEL DROP, SAN DIEGO, CA (US); POOJA SINHA, ONTARIO (CA); RUOLONG LIU, ONTARIO (CA); JOHN DANIEL CHAPARRO, ONTARIO (CA); VINODH RAMESH CUPPU, OCEANSIDE, CA (US); JOSEPH SCHWEIRAY LEE, SAN DIEGO, CA (US); JOHNNY JONE WAI KUAN, ONTARIO (CA); PAUL CHOW, ONTARIO (CA); ANIL VOOTUKURU, SAN DIEGO, CA (US); VINAY MITTER, SAN DIEGO, CA (US)

(21) Appl. No.: 14/588,812

(22) Filed: Jan. 2, 2015

Related U.S. Application Data
(60) Provisional application No. 62/073,606, filed on Oct. 31, 2014.

(51) Int. Cl. H04L 12/911

(52) U.S. Cl. CPC H04L 47/783; H04L 47/72

(57) ABSTRACT

A method and system for managing safe downtime of shared resources within a portable computing device are described. The method may include determining a tolerance for a downtime period for an unacceptable deadline miss element of the portable computing device. Next, the determined tolerance for the downtime period may be transmitted to quality-of-service (“QoS”) controller. The QoS controller may determine if the tolerance for the downtime period needs to be adjusted. The QoS controller may receive a downtime request from one or more shared resources of the portable computing device. The QoS controller may determine if the downtime request needs to be adjusted. Next, the QoS controller may select a downtime request for execution and then identify which one or more unacceptable deadline miss elements of the portable computing device that are impacted by the selected downtime request.

### PRIORITY AND RELATED APPLICATIONS STATEMENT

This application claims priority under 35 U.S.C. 119(e) to U.S. Provisional Application Ser. No. 62/073,606 filed on Oct. 31, 2014, entitled, “SYSTEM AND METHOD FOR MANAGING SAFE DOWNTIME OF SHARED RESOURCES WITHIN A PCD.” The contents of which are hereby incorporated by reference.

### DESCRIPTION OF THE RELATED ART

Portable computing devices (“PCDs”) are powerful devices that are becoming necessities for people on personal and professional levels. Examples of PCDs may include cellular telephones, portable digital assistants (“PDAs”), portable game consoles, palmtop computers, and other portable electronic devices.

PCDs typically employ systems-on-chips (“SOCs”). Each SOC may contain multiple processing cores that have deadlines which, if missed, may cause detectable/visible failures that are not acceptable during operation of a PCD. Deadlines for hardware elements, such as cores, are usually driven by amount of bandwidth (“BW”) a core receives from a shared resources, such as memory or buses, like dynamic random access memory (“DRAM”), Internal static random access memory (“SRAM”) memory (“IMEM”), or other memory such as a Peripheral Component Interconnect Express (“PCI-e”) external transport links over a short period of time. This short period of time depends on processing cores and is usually in the range of about 10 microseconds to about 100 milliseconds.

When certain processing cores do not receive a required memory BW over specified periods of time, failures may occur and which may be visible to the user. Lapses in required memory BW may occur when there is downtime for maintenance of the PCD or for when the PCD needs to change one or more modes of operation. These lapses in required memory BW may cause a failure which may be visible to a user.

For example, one visible failure may occur with a display engine for a PCD: it reads data from a memory element (usually DRAM) and outputs data to a display panel/device for a user to view. If the display engine is not able to read enough data from DRAM within a fixed period of time, then such an issue may cause a display engine to “run out” of application data and be forced display a fixed, solid color (usually blue or black) on a display due to the lack of display data available to the display engine. This error condition is often referred to in the art as “Display Underflow” or “Display Under Run” or “Display tearing,” as understood by one of ordinary skill in the art.

As another example of potential failures when a hardware element does not receive sufficient throughput or bandwidth from a memory element, a camera in a PCD may receive data from a sensor and write that data to the DRAM. If a sufficient amount of data is not written to DRAM within a fixed period of time, then this may cause the camera engine to lose input camera data. Such an error condition is often referred to in the art as “Camera overflow” or “Camera Image corruption,” as understood by one of ordinary skill in the art.

Another example for potential failure is a modem core not being able to read/write enough data from/to DRAM over a fixed period to complete critical tasks. If critical tasks are not completed within deadline, modem firmware may crash: voice or data calls of a PCD are lost for period of time or an internet connection may appear sluggish (i.e.—stuttering during an internet connection).

Accordingly, there is a need in the art for managing safe downtime periods within a PCD, which may utilize shared resources in order to reduce and/or eliminate the error conditions noted above that are noticeable in a PCD, such as in a mobile phone.

### SUMMARY OF THE DISCLOSURE

A method and system for managing safe downtime of shared resources within a portable computing device includes determining a tolerance for a downtime period for an unacceptable deadline miss element of the portable computing device. In this disclosure, unacceptable deadline miss (“UDM”) elements are those hardware and/or software elements which may cause significant or catastrophic failures of a PCD 100 as described in the background section. Next, the determined tolerance for the downtime period may be transmitted to a central location, such as to a quality-of-service (“QoS”) controller within the portable computing device.

The QoS controller may determine if the tolerance for the downtime period needs to be adjusted. If the tolerance needs to be adjusted, then the QoS controller may adjust the tolerance up or down depending on the UDM element which originated the tolerance.

The QoS controller may receive a downtime request from one or more shared resources of the portable computing device. The QoS controller may determine if the downtime request needs to be adjusted. If the QoS controller determines that the downtime request needs to be adjusted based on the type of device issuing the downtime request, the QoS controller may adjust the downtime request up or down in value.

Next, the QoS controller may select a downtime request for execution and then identify which one or more unacceptable deadline miss elements of the portable computing device that are impacted by the selected downtime request. The QoS controller may determine if impacted unacceptable deadline miss elements may function properly for a duration of the selected downtime request.

If the impacted unacceptable deadline miss elements may function properly during the duration of the selected downtime request, then the QoS controller may grant the downtime request to one or more devices which requested the selected downtime request.

If the impacted one or more unacceptable deadline miss elements may not function properly during the duration of the selected downtime request, then the QoS controller may not issue the downtime request until all unacceptable deadline miss elements may function properly for the duration of the selected downtime request.

During a wait period, the QoS controller may raise a priority of the one or more unacceptable deadline miss elements with a predetermined tolerable downtime period. Also during the wait period, the QoS controller may issue a command to adjust bandwidth of at least one of an unacceptable deadline miss element and non-unacceptable deadline miss element.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram of an exemplary system within a portable computing device (PCD) for managing safe downtime of shared resources.

FIG. 2 is a functional block diagram of an exemplary TDP level sensor for an unacceptable deadline miss (“UDM”) hardware element.

FIG. 3 is a functional block diagram of another exemplary TDP level sensor for an unacceptable deadline miss (“UDM”) hardware element according to another exemplary embodiment.

FIG. 4 is one exemplary embodiment of a downtime mapping table for managing downtime requests from one or more downtime requesting elements, such as memory controllers.

FIG. 5 is another exemplary embodiment of a downtime mapping table for managing downtime requests from one or more downtime requesting elements, such as memory controllers.

FIG. 6 is a an exemplary embodiment of a QoS policy mapping table for managing downtime requests from one or more downtime requesting elements by throttling one or more UDM elements and/or Non-UDM elements.

FIG. 7 is a logical flowchart illustrating an exemplary method for managing safe downtime for shared resources within a PCD.

FIG. 8 is a functional block diagram of an exemplary, non-limiting aspect of a PCD in the form of a wireless telephone for implementing methods and systems for managing safe downtime for shared resources within a PCD.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “processing component” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” and “chip” are used interchangeably. Moreover, a CPU, DSP, or a chip may be comprised of one or more distinct processing components generally referred to herein as “core(s).”

In this description, the terms “workload,” “process load” and “process workload” are used interchangeably and generally directed toward the processing burden, or percentage of processing burden, associated with a given processing component in a given embodiment. Further to that which is defined above, a “processing component” may be, but is not limited to, a central processing unit, a graphical processing unit, a core, a main core, a sub-core, a processing area, a hardware engine, etc. or any component residing within, or external to, an integrated circuit within a portable computing device.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, a notebook computer, an ultrabook computer, a tablet personal computer (“PC”), among others. Notably, however, even though exemplary embodiments of the solutions are described herein within the context of a PCD, the scope of the solutions are not limited to application in PCDs as they are defined above. For instance, it is envisioned that certain embodiments of the solutions may be suited for use in automotive applications. For an automotive-based implementation of a solution envisioned by this description, the automobile may be considered the “PCD” for that particular embodiment, as one of ordinary skill in the art would recognize. As such, the scope of the solutions is not limited in applicability to PCDs per se. As another example, the system described herein could be implemented in a typical portable computer, such as a laptop or notebook computer.

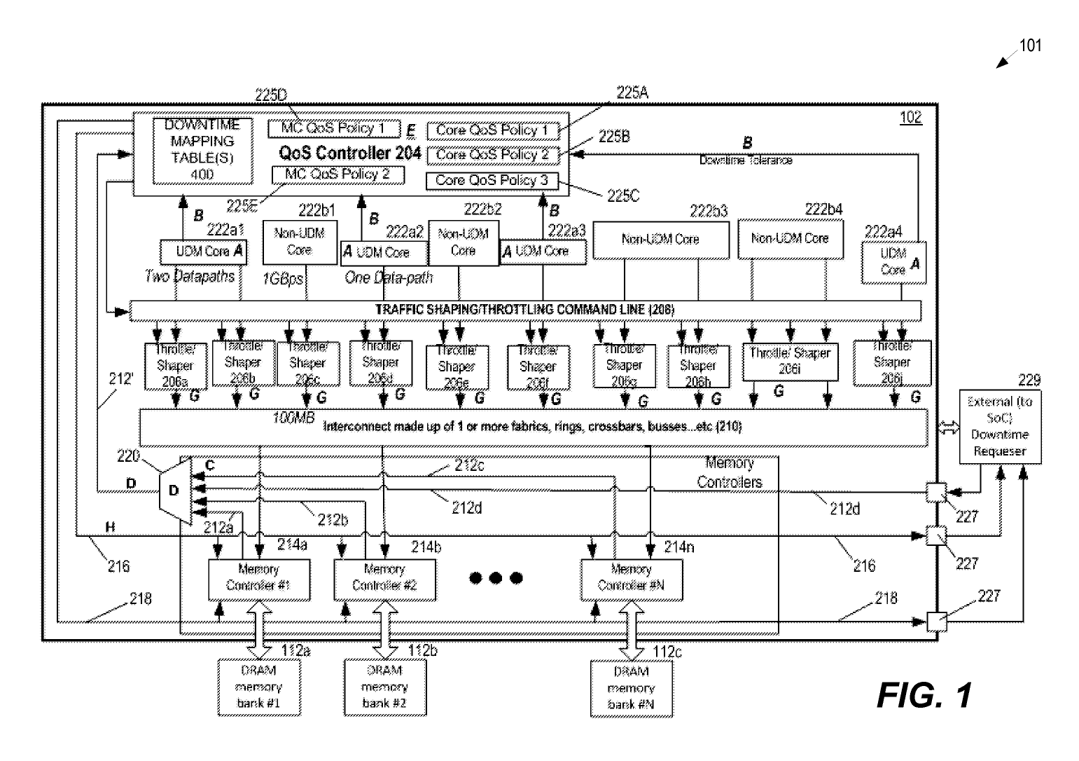

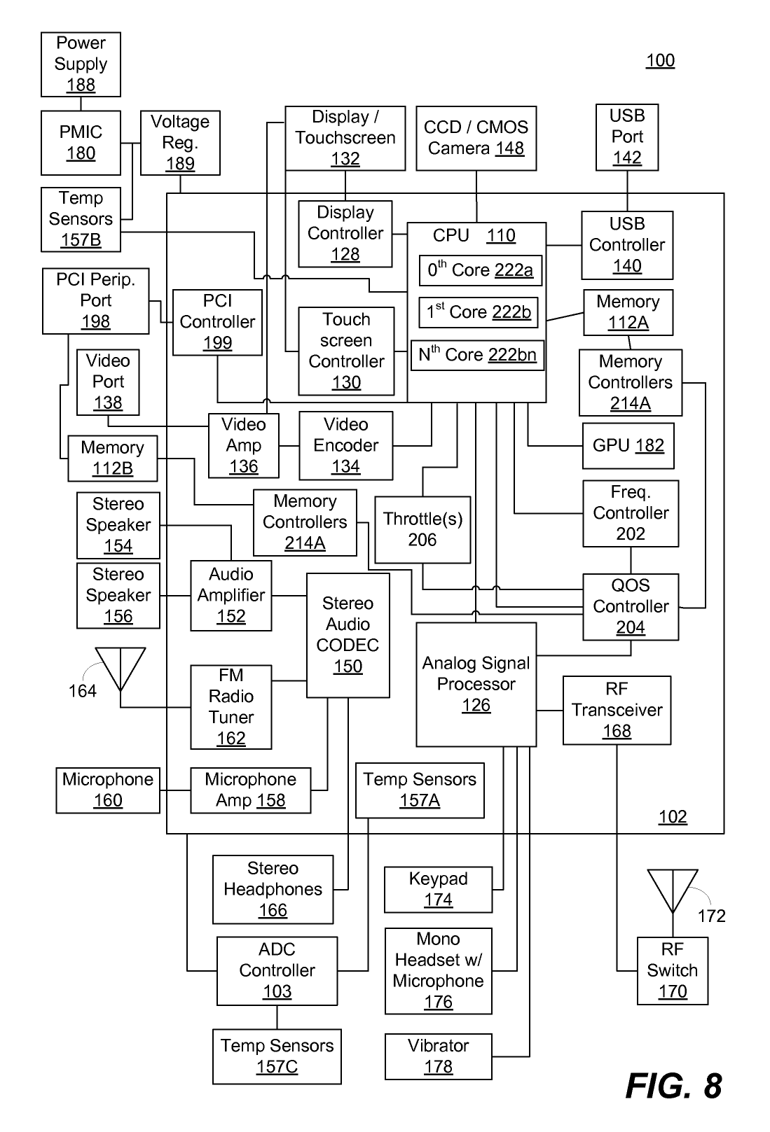

FIG. 1 is a functional block diagram of an exemplary system 101 within a portable computing device (“PCD”) 100 (See FIG. 8) for managing safe downtime of shared resources. The system 101 may comprise a system-on-chip (“SoC”) 102 as well as off-chip devices such as memory devices 112 and external downtime requesters 229. On the SoC 102, the system 101 may comprise a quality of service (“QoS”) controller 204 that is coupled to one or more unacceptable deadline miss (“UDM”) elements, such as UDM cores 222a. Specifically, the QoS controller 204 may be coupled to four UDM cores 222a1, 222a2, 222a3, and 222a4.

In this disclosure, unacceptable deadline miss (“UDM”) elements are those hardware and/or software elements which may cause significant or catastrophic failures of a PCD 100 as described in the background section listed above. Specifically, UDM elements 222a are those elements which may cause exemplary error conditions such as, but not limited to, “Display Underflows,” “Display Under runs,” “Display tearing,” “Camera overflows,” “Camera Image corruptions,” dropped telephone calls, sluggish Internet connections, etc. as understood by one of ordinary skill in the art.

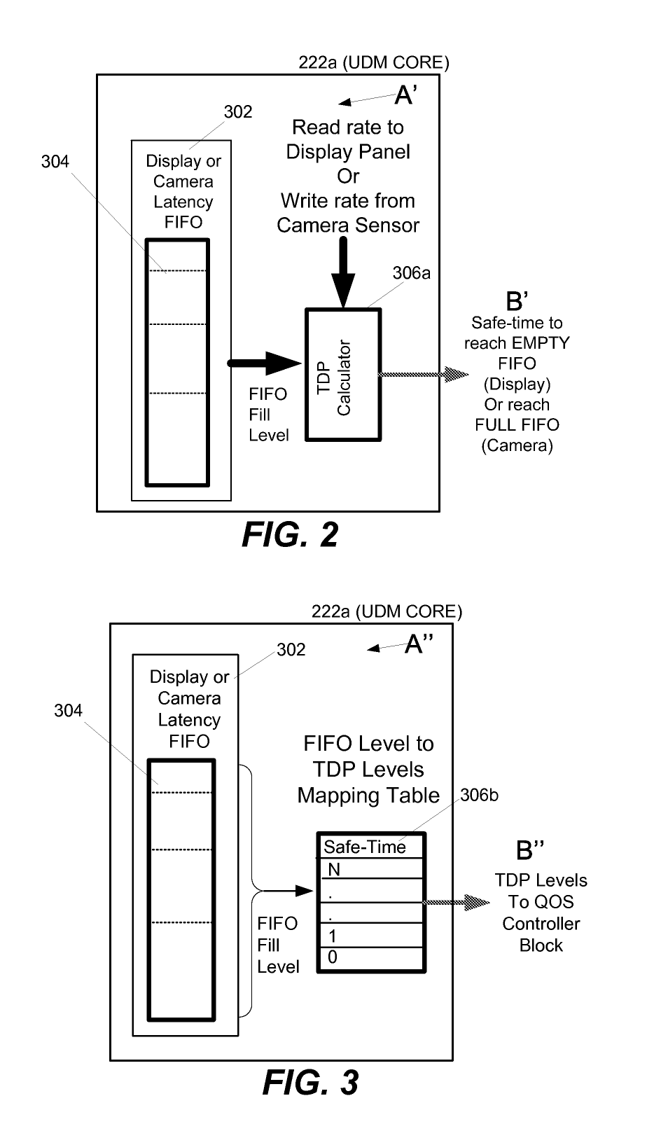

Any hardware and/or software element of a PCD 100 may be characterized and treated as a UDM element 222a. Each UDM element 222a, such as UDM cores 222a1-a4, may comprise a tolerable downtime period (“TDP”) sensor “A” which produces a TDP signal “B” that is received in monitored by the QoS controller 204. TDP signal “B” may comprise an amount of time or it may comprise a level, such as a level one out of a five level based system. Further details of the TDP sensor A which produces TDP level or duration amount signals B will be described in further detail below in connection with FIG. 2.

Other hardware elements such as Non-UDM cores 222b1-b4 may be part of the PCD 100 and the system 101. The Non-UDM cores 222b1-b4 may not comprise or include TDP level sensors A. Alternatively, in other exemplary embodiments, it is possible for Non-UDM cores 222b1-b4 to have TDP level sensors A, however, these sensors A of these Non-UDM hardware elements 222b are either not coupled to the QoS controller 204 or a switch (not illustrated) has turned these TDP level sensors A to an “off” position such that the QoS controller 204 does not receive any TDP level signals B from these designated/assigned Non-UDM hardware elements 222b.

Each UDM-core 222a and Non-UDM core 222b may be coupled to a traffic shaper or traffic throttle 206. Each traffic shaper or traffic throttle 206 may be coupled to an interconnect 210. The interconnect 210 may comprise one or more switch fabrics, rings, crossbars, buses etc. as understood by one of ordinary skill in the art. The interconnect 210 may have additional elements, which are omitted for simplicity, such as controllers, buffers (caches), drivers, repeaters, and receivers, to enable communications. Further, the interconnect 210 may include address, control, and/or data connections to enable appropriate communications among its aforementioned components. The interconnect 210 may be coupled to one or more memory controllers 214. In alternative examples of the system 101, the traffic shaper or traffic throttle 206 may be integrated into the interconnect 210.

The memory controllers 214 may be coupled to memory elements 112. Memory elements 112 may comprise volatile or non-volatile memory. Memory elements 112 may include, but are not limited to, dynamic random access memory (“DRAM”), or internal static random access memory (“SRAM”) memory (“IMEM”).

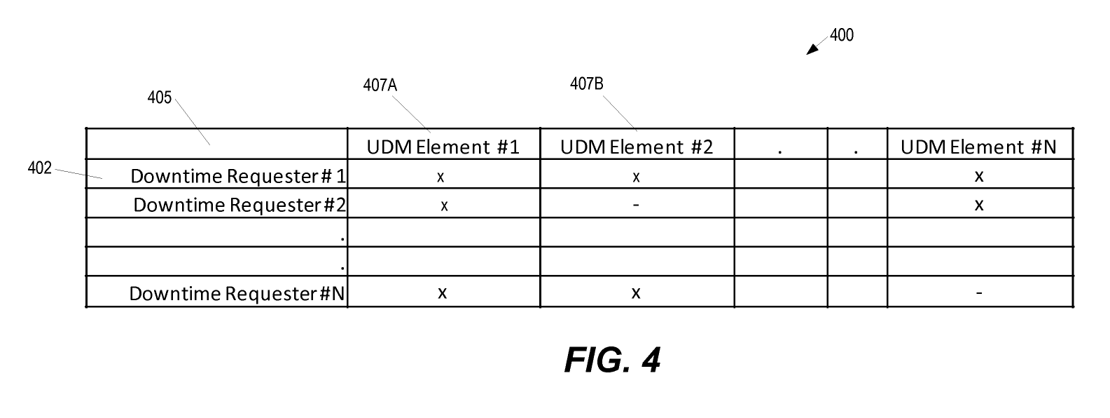

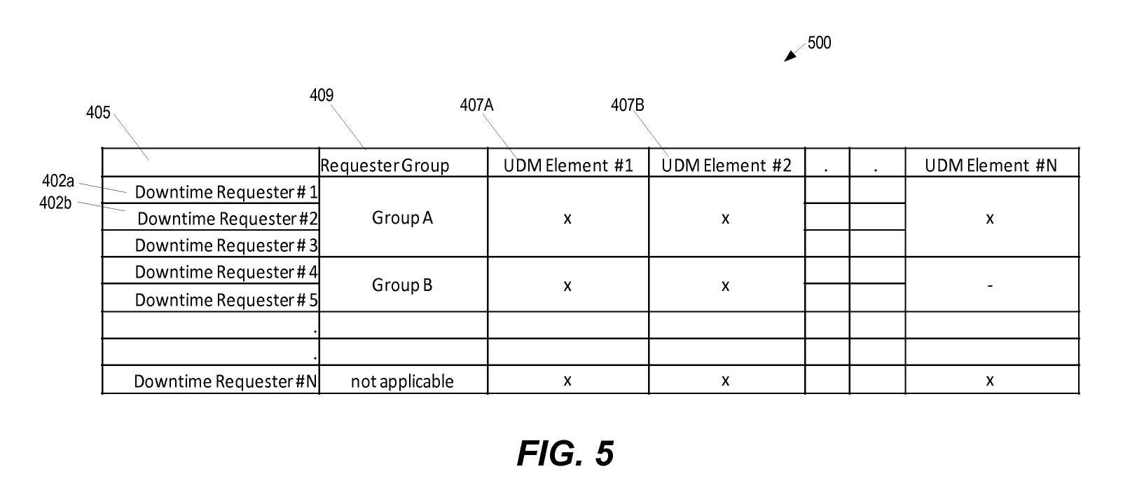

The QoS controller 204 may issue command signals to individual traffic shapers or traffic throttles 206 via the throttle level command line 208. Similarly, the QoS controller 204 may issue memory controller downtime grant signals to individual memory controllers 214 via a data line 218 (also designated with the reference character “H” in FIG. 1). The QoS controller 204 may communicate downtime grant signals not necessarily in order or when requests are made. Some downtime requesters or requesting elements, like memory controllers 214, may receive their downtime grants quickly while others may wait a long time depending upon the UDM impact determination made by the QoS controller 204 using tables 400 and 500. Further details of tables 400 and 500 will be described below in connection with FIGS. 4-5.

The QoS controller 204 may also issue commands along a data line 218 to change one or more shared resource policies of the memory controllers 214. The QoS controller 204 may monitor the TDP level signals B generated by UDM elements 222a, such as, but not limited to, UDM cores 222a1-a4. The QoS controller 204 may also monitor interconnect and memory controller frequencies.

As discussed above, as one of its inputs, the QoS controller 204 receives TDP level signals B from each of the designated UDM hardware elements 222, such as UDM cores 222a. Each UDM hardware 222 element has a TDP level sensor A that produces the TDP level signals B.

TDP level signals B may comprise information indicating levels or amounts of downtime at which a UDM hardware element 222a may tolerate low or no bandwidth before it is in danger of not meeting a deadline and/or it is in danger of a failure. The failure may comprise one or more error conditions described above in the background section for hardware devices such as, but not limited to, a display engine, a camera, and a modem.

Each TDP level signal B may be unique relative to a respective UDM element 222a. In other words, the TDP level signal B produced by first UDM core 222a1 may be different relative to the TDP level signal B produced by second UDM core 222a2. For example, the TDP level signal B produced by the first UDM core 222a1 may have a magnitude or scale of five units while the TDP level signal B produced by the second UDM core 222a2 may have a magnitude or scale of three units. The differences are not limited to magnitude or scale: other differences may exist for each unique UDM element 222a as understood by one of ordinary skill in the art. Each TDP level signal B generally corresponds to a downtime value that can be tolerated by the UDM element 222a before a risk of failure may occur for the UDM element 222a.

The QoS controller 204 monitors the TDP level signals B that are sent to it from the respective UDM hardware elements 222, such as the four UDM cores 222a1-222a4 as illustrated in FIG. 1. In addition to the TDP level signals B being monitored, the QoS controller 204 also monitors the interconnect and memory controller frequencies as another input. Based on the TDP level signals B and the interconnect and memory controller frequencies 218, the QoS controller 204 determines if an appropriate QoS policy for each hardware element 222 being monitored, such as the four UDM cores 222a1-222a4 as well as the Non-UDM cores 222b1-b4 as illustrated in FIG. 1.

The QoS controller 204 maintains individual QoS policies 225 for each respective hardware element 222 which includes both UDM cores 222a1-a4 as well as Non-UDM cores 222b1-b4. While the individual QoS policies 225 have been illustrated in FIG. 1 as being contained within the QoS controller 204, it is possible that the QoS policy data for the policies 225 may reside within memory 112 which is accessed by the QoS controller 204. Alternatively, or in addition to, the QoS policies 225 for each hardware element 222 may be stored in local memory such as, but not limited to, a cache type memory (not illustrated) contained within the QoS controller 204. Other variations on where the QoS policies 225 may be stored are included within the scope of this disclosure as understood by one of ordinary skill in the art.

The QoS controller 204 may also maintain one or more downtime mapping tables 400, 500 (See FIGS. 4-5) for comparing with the TDP signals B received from the UDM elements 222. The QoS controller 204 may monitor TDP signals from all UDM elements 222 for any increase(s)/decrease(s) indicating the downtime that each UDM element 222a can withstand: the QoS controller 204 may adjust the value/magnitude of the received TDP Level B that each UDM element 222a may tolerate in order to add more of a safety margin to the system 101.

This adjustment to TDP signals B may include re-mapping a TDP-level/value/quantity to a higher level or a lower level depending on the UDM element 222a which originated the TDP signal B. The QoS controller 204 may be programmed, either in software, hardware, and/or firmware to understand which UDM element 222a is sensitive to what downtime client.

If a UDM element 222a, such as core 222a, is sensitive to multiple downtime requesters, the UDM element's downtime tolerance usually should represent the minimum of all downtime tolerances OR the UDM element 222a must send a downtime tolerance for each of the downtime requesters that it is sensitive to. The QoS Controller 204 may receive downtime requests “D” from data line 212′ (212-“prime”) from all downtime requesters, which may include, but are not limited to, Non-UDM elements like interconnect 210, memory controllers 214, and/or memory elements 112.

When a request for downtime comes into the QoS controller 204 along data line 212′, it usually comprises a requested downtime period (“RDP”). The requests for downtime from multiple resources may be aggregated with an aggregator 220. The aggregator may comprise a multiplexer as understood by one of ordinary skill in the art. Upon receiving the request (that may comprise a requested downtime period “RDP”), the QoS Scheduler 204 may check downtime mapping tables 400, 500 (See FIGS. 4-5) to identify what UDM element 222a is affected by the downtime request and it may make a decision by examining the tables 400, 500. Further details of tables 400, 500 are illustrated in FIGS. 4-5 that are described below.

In the exemplary embodiment of FIG. 1, downtime request data lines 212a-d are illustrated. Downtime request lines 212a-c are coupled to respective memory controllers 214a-n. Meanwhile, downtime request line 212d is coupled off-chip (off SoC 102) via an SoC pin 227 with an external downtime requester 229. The external downtime requester 229 may comprise any type of device that may be coupled to an SoC 102. According to one exemplary embodiment, the external downtime requester 229 may comprise a peripheral device that uses a Peripheral Component Interconnect Express (“PCI-e”) port 198 (not illustrated in FIG. 1, but see FIG. 8).

Some of the downtime requests referenced by letter “C” in FIG. 1, such as from memory controllers 214 and the external downtime requester 229 along data line 212′, may be synchronized and therefore requests may be bundled into a group rather than processed individually as will be described in connection with FIG. 5 illustrating downtime mapping table 500 described below. The requests at C may also be aggregated and/or multiplexed at letter “D.”

With the downtime requests received along data line 212′, the QoS controller 204 may use downtime mapping table 500 to know that a predetermined group of requesters, such as memory controllers 214, are synchronized. In this case, it treats one request from one downtime requester in the group as a request from all requesters in the group. Any grants from the QoS controller 204 are transmitted to all downtime requesting elements in the group along data line 216 also designated by letter “H” in FIG. 1.

The QoS controller 204 associates which UDM elements 222a are impacted by the downtime of each shared resource. If all UDM elements 222a that are dependent on a shared resource which is requesting a downtime are able to withstand the requested down-time, the down-time request may be granted (to one or more requesting shared resources, such as memory controllers 214 and external downtime requester 229). If not all UDM elements 222a are able to withstand the requested downtime, the QoS controller 204 has several modes for reaction:

Mode 1: wait until all UDM elements 222a can operate during the requested downtime; OR

Mode 2: actively manipulate traffic in the system 101 using shapers/throttles 206 to improve down-time tolerance of UDM elements 222a, such as UDM cores 222a1-a4 illustrated in FIG. 1.

Once a downtime request is granted, the QoS controller 204 may also optionally shape/throttle non-UDM elements 222b (all or some) via throttle/shapers 206 during downtime to prevent them from generating requests that flood the system 101 once a particular downtime is over/finished/completed. Once a requested downtime period is completed/finished, the QoS controller 204 may also optionally shape/throttle non-UDM elements 222b (all or some) for a predefined/predetermined duration to ensure UDM elements 222a recover from the granted downtime period. The QoS controller 204 may also optionally space out grants of successive down-time requests to ensure UDM elements 222a recover from all the granted downtime periods.

The QoS controller 204 may shape/throttle Non-UDM elements 222b during granted downtime periods as well as outside of granted downtime periods. By throttling/shaping aggressor Non-UDM elements 222b, or by throttling UDM elements 222a that have sufficiently high TDP, UDM elements 222a with insufficient TDP time receive more bandwidth and/or lower latency from the system 101 thus improving their tolerance to future downtime requests.

As apparent in FIG. 1, while the QoS controller 204 may be receiving TDP level signals B only from UDM cores 222a1-222a4, the QoS controller 204 does monitor and control each hardware element 222, which includes Non-UDM cores 222b1-b4 in addition to UDM cores 222a1-a4. The application of the QoS policy for each hardware element 222 being monitored is conveyed/relayed via the throttle level command line 208, also designated by reference character “F”, to each respective shaper/throttle 206 which is assigned to a particular hardware element 222.

Each shaper/throttle 206 may comprise a hardware element that continuously receives throttle level commands from the traffic shaping/throttling level command line 208 that is managed by the QoS controller 204. Each traffic shaper or traffic throttle 206 adjusts incoming bandwidth from a respective core 222 to match the bandwidth level “G” specified by the QoS controller 204 via the throttle level command line 208. Each throttle 206 may be implemented with any or a combination of the following technologies: a discrete logic circuit(s) having logic gates for implementing logic functions upon data signals, an application specific integrated circuit (“ASIC”) having appropriate combinational logic gates, one or more programmable gate array(s) (“PGA”), one or more field programmable gate array (“FPGA”), etc.

As stated previously, each hardware element 222 has a respective traffic shaper or traffic throttle 206 that is coupled to the traffic shaping/throttling level command line 208 which is under control of the QoS controller 204. This is but one important aspect of the system 101 in that the QoS controller 204 has control over each hardware element 222, not just the UDM hardware elements 222a which may send or originate the TDP level signals B.

Since the QoS controller 204 is in direct control of each hardware element 222, that includes both elements 222a and 222b, the QoS controller 204 may throttle the traffic or bandwidth of aggressor hardware elements 222, such as aggressor cores 222 which may or may not be UDM type hardware elements. By shaping/throttling bandwidth of aggressor hardware elements 222, such as Non-UDM cores 222b1-b4, then UDM cores 222a1-a4 may receive more bandwidth and/or lower latency from the system 101 thereby reducing respective TDP levels of respective hardware elements 222, such as UDM cores 222a1-a4. This shaping/throttling of aggressor hardware elements 222, like Non-UDM hardware elements 222b by the QoS controller 204 may also prevent and/or avoid failures for the UDM hardware elements 222a as discussed above in the background section.

The QoS controller 204 may generate and issue memory controller shared resource policy commands via the memory line 218 illustrated in FIG. 1. This memory controller shared resource policy data is determined by the QoS controller 204 based on the TDP level signals B from UDM hardware elements 222a as well as interconnect and memory controller frequencies.

As understood by one of ordinary skill in the art, each memory controller 214 may have multiple shared resource policies, such as DRAM resource optimization policies. All of these policies typically favor data traffic with higher priority over data traffic with lower priority. The delay between receiving high-priority transactions and interrupting an ongoing stream of low-priority transactions to the memory or DRAM 112 may be different for each shared resource policy.

If shared resource comprises a memory controller 214, then its policy may be referred to as a “memory controller QOS policy” that causes the memory controller 214 to change its optimization policy to aid UDM elements 222a achieve the required TDP for a requested downtime. If a shared resource comprises an on-chip PCI-controller 199 (See FIG. 8) or an off-chip external requester 229, such as a PCI peripheral port 198, it can change its internal arbitration policy to favor traffic from/to UDM elements 222a to aid them in achieving the required TDP for a requested downtime.

In the exemplary embodiment of FIG. 1, the first UDM core 222a1 has two data paths that couple with the interconnect 210. Each data path from the first UDM core 222a1 may have its own respective traffic shaper/throttle 206, such as first traffic shaper/throttle 206a and second traffic shaper/throttle 206b.

In FIG. 1, as one example of traffic shaping/throttling for a potential Non-UDM aggressor core 222b1, the first Non-UDM aggressor core 222b1 may attempt to issue an aggregate bandwidth of one gigabyte per second (“GBps”) in a series of requests to the interconnect 210. These successive requests are first received by the traffic shaper/throttle 206c. The traffic shaper/throttle 206c, under control of the QoS controller 204 and a respective core QoS policy 225B assigned to the Non-UDM core within the QoS controller, may “shape”, “throttle” these series of requests such that the bandwidth presented to interconnect decreases from 1 GBps down to 100 megabyte bit per second (“MBps”) so that one or more UDM cores 222a have more bandwidth for their respective memory requests via the interconnect 210.

Referring now to FIG. 2, this figure is a functional block diagram of an exemplary TDP level sensor A′ (“prime”) for an unacceptable deadline miss (“UDM”) hardware element 222, such as a display core 222a illustrated in FIG. 1 and in FIG. 8. The TDP level sensor A may comprise a first-in, first-out (FIFO) data buffer 302 and a FIFO level TDP calculator 306a. Each FIFO data buffer 302 may comprise a set of read and write pointers, storage and control logic. Storage may be static random access memory (“SRAM”), flip-flops, latches or any other suitable form of storage.

According to one exemplary embodiment, each FIFO data buffer 302 may track data that is received by the hardware element 222. For example, suppose that the hardware element 222 comprises a display engine. The display engine 222 or a display controller 128 (see FIG. 8) would read from DRAM memory 112 display data that would be stored in the FIFO data buffer 302. The display engine 222 (or display controller 128 of FIG. 8) would then take the display data from the FIFO dater buffer 302 and send it to a display or touchscreen 132 (see FIG. 8).

The FIFO data buffer 302 has a fill level 304 which may be tracked with a TDP calculator 306a. As the fill level 304 for the FIFO data buffer 302 decreases in value, the TDP level would decrease because if the FIFO data buffer 302 becomes empty or does not have any data to send to the display or touchscreen 132, then the error conditions described above as the “Display Underflow” or “Display Under run” or “Display tearing,” may occur. The output of the TDP calculator 306a is the TDP level signal B that is sent to the QoS controller 204 as described above.

For the display engine example, the Tolerable Downtime Period (“TDP”) for the display engine 222 represents the time it would take drain the present FIFO level to zero (by reading data from FIFO and sending to display 132 of FIG. 8) if the DRAM memory 112 was not providing any read bandwidth due to down time. TDP may comprise the “raw” time to empty the FIFO 302 as describe above multiplied by a factor for additional safety. This means the TDP calculator 306 may determine the “raw” time and multiply it by the factor of safety which becomes the TDP level or value B as illustrated in FIG. 2.

According to another exemplary embodiment, suppose the UDM hardware element 222a of FIG. 2 comprises a camera controller. The camera controller (not illustrated) within the SoC 102 reads data from the camera sensor 148 (See FIG. 8) and stores it within the FIFO data buffer 302. The camera controller then outputs the camera data from the FIFO data buffer 302 to DRAM memory 112. In this example embodiment, if the FIFO data buffer 302 overflows from the camera data, then some camera data may be lost and the error conditions of “Camera overflow” or “Camera Image corruption,” may occur.

So according to this exemplary embodiment, as the FIFO fill level 304 increases, then the TDP level B decreases as determined by the TDP calculator 306a. This TDP level of the camera sensor 148 is opposite to the TDP level display embodiment described previously as understood by one of ordinary skill in the art. In other words, TDP for this camera controller embodiment comprises the time it would take to raise FIFO level 304 from current level to FULL if the DRAM memory 112 was not responding to write transactions due to downtime.

Referring now to FIG. 3, this figure is a functional block diagram of another exemplary TDP level sensor A″ (“double-prime”) for an unacceptable deadline miss (“UDM”) hardware element 222 according to another exemplary embodiment, such as a display core 222a illustrated in FIG. 1 and in FIG. 8. The display or camera engine 222a can be programmed to use the TDP calculator 306b to issue TDP Levels (rather than an actual time) whenever: for a read from the memory engine in a display engine embodiment, the FIFO level 304 is above a certain level; for a write function to a memory engines in a camera embodiment, the FIFO level 304 is below a certain level.

The TDP calculator 306b may comprise a FIFO level to TDP Level mapping table. The Tolerable Downtime Period (“TDP”) Levels determined by the TDP calculator 306b may comprise a set of numbers (0, 1, 2, 3 . . . N) that each indicates to the QoS Controller 204 that this UDM element 222a can tolerate a pre-determined amount of time that is proportional to current FIFO fill. If a UDM element 222a is sensitive to multiple downtime requesters, the UDM element 222a via the TDP calculator 306b either computes a TDP or TDP Level B that represents the minimum downtime tolerance for all downtime requestors OR it may send different TDP/TDP Level signals B, each corresponding to a different downtime requester. Alternatively, the TDP calculator may send a TDP/TDP-level B that represents the tolerance of a UDM element 222a to a set of downtime requesters that may be entering into a downtime period simultaneously. For example, a set of DRAM controllers 214 all running in a synchronous manner may enter into a downtime period at the same time due to a frequency switching event.

According to other exemplary embodiments, the UDM element 222a of FIGS. 2-3 and its respective TDP calculator 306 may comprise a software-based module or firmware (not illustrated in FIG. 2) on a programmable compute engine that continuously checks on a fraction of a task or tasks already completed by the UDM element 222a and elapsed time since a task for the UDM element 222a has started.

The software (“SW”) or firmware (“FW”) embodiment of the TDP calculator 306 may estimate completion time for the task and compares it to target completion time (specified by an operator). If the estimated completion time determined by the TDP calculator 306 is greater than (>) a target completion time, the SW/FW of the TDP calculator 306 indicates the difference in the TDP signal B to the QOS Controller 204. The value of the computed TDP signal/level B can be reduced by the SW/FW of the TDP calculator 306 to account for unforeseen future events or computation inaccuracy in the estimated completion time based on: elapsed task time, fraction of completed task, target completion time, and concurrent load on a compute engine of the UDM element 222a.

According to another exemplary embodiment, the UDM element 222a may comprise a hardware (“HW”) element for the TDP calculator 306 (not illustrated) that comprises a fixed function compute engine that continuously checks fraction of tasks already completed and elapsed time since one or more tasks have started for execution by the UDM element 222a. This dedicated HW element for the TDP calculator 306 may estimate completion time for a task and compares it to a target completion time (specified by user).

If the estimated completion time determined by the TDP calculator 306 is greater than (>) a target completion time, then this HW element of the TDP calculator 306 indicates the difference in the TDP signal B to the QOS Controller 204. The value of the computed TDP signal/level B can be reduced by the HW element of the TDP calculator 306 to account for unforeseen future events or computation inaccuracy in the estimated completion time based on: elapsed task time, fraction of completed task, target completion time, and concurrent load on a compute engine of the UDM element 222a.

In view of FIGS. 2-3 and their illustrations of the TDP calculator 306 which is generally referenced by letter “A” in FIG. 1, it is apparent that each UDM element 222a transmits an indication (TDP signal B) of the duration of down-time it can withstand to the QoS (Downtime Tolerance) Controller 204. That indication or signal B may comprise: an explicit TDP value indicating how long a UDM element 222a can withstand a data downtime; or TDP levels each indicating that UDM element 222a can withstand a pre-defined Safe-Time value.

The TDP levels referenced as letter “B” in FIGS. 1-3 may be defined in monotonic manner (increasing or decreasing) but need not be equally distributed. For example, a “Level 2” may indicate that a UDM element 222a, like a core 222a, can withstand more downtime than a “Level 1.” As another example, a “Level 2” value for one UDM element 222a, like a core, may indicate that it is able to withstand more downtime than a Level 2 indicated by another UDM element 222a, such as another core.

Referring back to FIG. 1, downtime requests labeled as “C” in FIG. 1 may be generated by DRAM memory controllers 214, or PCI controller cores (not illustrated), or an internal SRAM controller (not illustrated). Each downtime requesting element may internally generate estimate of the requested downtime period (“RDP”) and generate a request to proceed with a downtime equal to or less than the RDP.

Each downtime requesting element, such as a memory controller 214, determines when to request a downtime and for how long. For example, a PCI-E controller that may comprise external downtime requester 229 or a DRAM memory controller 214 may need to periodically re-train its link to adjust for temperature/voltage variations over time. Each controller 229 or 214 may have the capability of determining how long a DRAM/PCI bus will be down during retraining and the controller 214/229 may transmit this information as downtime request C in FIG. 1 along data line 212 to QoS controller 204.

A memory controller 214 is usually tasked by frequency control HW/SW to change DRAM frequency. The DRAM controller 214 has the capability to determine how long the DRAM bus will be down during frequency switching (for PLL/DLL lock and link training) and this information may be conveyed as “C” along data line 212 as a downtime request to QoS controller 204.

In addition to a downtime request, controllers, such as memory controllers 214, may also generate a priority for their downtime request that is sent to the QoS controller 204 along data lines 212a-d. The priority of a downtime request may indicate a level of importance of the requesting device (i.e., a numeric value, such as, but not limited to 0, 1, 2, 3 . . . etc.). Alternatively, the priority of a request may indicate a maximum time that the requesting device may wait before it has to enter into downtime—starting from the time the request was made. Requesting devices, like memory controllers 214, with earlier maximum wait times may be given a priority value over requesting devices with longer maximum wait times by the QoS controller 204.

As apparent to one of ordinary skill in the art, shared resource controllers may reside outside the SoC 102, such as external downtime requester 229. For external controllers, requests for downtime and grants or control time are usually communicated via SoC pins 227 as illustrated in FIG. 1.

Referring to reference character “D” in FIG. 1, downtime request data lines 212a-d may be aggregated and coupled to an aggregator or multiplexer 220. Multiple downtime requests or requests for downtime periods (“RDPs”) from all masters, such as controllers 214a-n and the external downtime requester 229, may be merged together with the aggregator or multiplexer 220 and routed/transmitted back to the QoS controller 204 along the aggregate downtime request data line 212′ (“prime”). This means that both internal and external downtime requests relative to the SoC 102 may be merged. However, in other exemplary embodiments (not illustrated) it is possible to keep external downtime requests separate from internal requests (relative to the SoC 102). Further, in other exemplary embodiments, each downtime requesting device may be provided with its own separate downtime request data line 212.

As noted previously, each RDP request along downtime request data lines 212 may have a priority or urgency level associated with it. The multiplexer or aggregator 220 may comprise software, hardware, and/or firmware for prioritizing requests of higher priority when sending multiple requests to the QoS controller 204 along aggregate data request line 212′ (212-“prime”).

If more a plurality of downtime requests from two or more downtime requesting devices are synchronized (i.e. where both requesting devices may have a simultaneous downtime) these downtime requests may be aggregated by the aggregator/multiplexer 220 into a single request. In this scenario, the QOS controller 204 may treat this group of downtime requesting devices as a single downtime requesting device.

Alternatively, if the aggregator/multiplexer 220 is designed to be more simple from a software and/or hardware perspective, multiple downtime requests received by the multiplexer 220 may not be aggregated and sent in a “raw” state to the QoS controller 204. In this scenario, the QoS controller 204 may determine (through a lookup table, such as tables 400 and 500 described below in connection with FIGS. 4-5) that a particular group of downtime requesting devices are synchronized together and may be treated like a single requester.

The QoS controller 204 may comprise a state machine. The state machine may be implemented with any or a combination of the following technologies: a discrete logic circuit(s) having logic gates for implementing logic functions upon data signals, an application specific integrated circuit (“ASIC”) having appropriate combinational logic gates, one or more programmable gate array(s) (“PGA”), one or more field programmable gate array (“FPGA”), a microcontroller running firmware, etc.

As described above in connection with FIG. 1, the QoS controller 204 may receive TDP level signals B from one or more UDM elements 222. Each TDP level signal B may be re-mapped by the QoS controller 204 to a lower or higher level that may be set/established by an operator and/or manufacturer of the PCD 100.

For example, a TDP level signal B from a display controller 128 having a magnitude of three units on a five-unit scale may be mapped/adjusted under an operator definition to a magnitude of five units, while a TDP level of two units from a camera 148 may be mapped/adjusted under the operator definition to a magnitude of one unit. For this exemplary five-unit TDP level scale, a magnitude of one unit may indicate an lower amount of time for a downtime period that may be tolerated by a UDM element 222a, while a magnitude of five units may indicate a higher amount of time for a downtime period that may be tolerated by a UDM element 222a.

In this example, the operator definition may weight/shift the TDP level signals B originating from the UDM element of a display controller 128 “more heavily” compared to the TDP level signals B originating from the UDM element of a camera 148. That is, the TDP level signals B from the display controller 128 are elevated to higher TDP levels while the TDP level signals B from the camera 148 may be decreased to lower TDP levels. This means that an operator/manufacturer of PCD 100 may create definitions/scaling adjustments within the QoS controller 204 that increase the sensitivity for some UDM elements 222 while decreasing the sensitivity for other UDM elements. The operator definition/scaling adjustments which are a part of the mapping function performed by the QoS controller may be part of each QoS policy 225 assigned to each UDM element 222a and a respective traffic shaper/throttle 206.

The QoS controller 204 may also monitor the frequencies 218 of both the memory controllers 214 and the interconnect 210. For each UDM core 222a and non-UDM core 222, the QoS Controller 204 may use remapped TDP levels and frequencies of the interconnect 210 and/or the memory controllers 214 to compute [through formula(s) or look-up table(s)] a QoS policy 225 for each core 222 and its traffic shaper/throttle 206 which produces throttle traffic shaper/throttle “F”. Each policy 225 may specify interconnect frequency(ies) 220A or traffic throttle/shaping level “G”. The QoS policy 225 generated for each core 222 by the QoS controller may also include compute/dictate memory controller QoS Policy data that is transmitted along data line 218 that is received and used by the one or more memory controllers 214a-N for selecting one or more memory controller efficiency optimization policies and/or shared resource policies.

As part of its mapping algorithm, TDP level signals B from one UDM core 222 and/or one Non-UDM core 222b may not impact all other cores 222. The QoS controller 204 may have programmable mapping that is part of each policy 225 of which select UDM cores 222a may be designated to affect/impact other cores 222.

For example, TDP level signals from a display controller 128 (see FIG. 8) designated as a UDM element 222a may cause bandwidth shaping/throttling to traffic from a GPU 182 (see FIG. 8) and a digital signal processor (“DSP”) or analog signal processor 126 (see FIG. 9) but not the CPU 110 (see FIG. 8).

As another example, TDP level signals B from camera 148 (see FIG. 8) may be programmed according to a QoS policy 225 to impact the QOS policy (optimization level) of the memory controller 214 assigned and as well as the frequency of a interconnect 210. Meanwhile, these TDP level signals B from the camera 148 are not programmed to cause any impact on a DRAM optimization level communicated along data line 218 from QoS controller 204. As a graphical example of mapping, a TDP level signal B1 of a first UDM core 222a1 may “mapped” to both the first policy 225A and the second policy 225B. Similarly, a TDP level signal B2 of a second UDM core 222a2 may be “mapped” to both the second policy 225B and the first policy 225A.

This mapping of TDP level signals B from UDM elements 222 may be programmed to cause the QoS controller 204 to execute anyone or a combination of three of its functions: (i) cause the QoS controller 204 to issue commands to a respective bandwidth shaper/throttle 206 to shape or limit bandwidth of a UDM and/or Non-UDM element 222b (also referred to as output G in FIG. 1); (ii) cause the QoS controller 204 to issued commands 220A to a frequency controller (not illustrated) to change frequency of the interconnect 210; and/or (iii) cause the QoS controller 204 to issue memory controller QoS policy and/or shared resource signals along data line 218 to one or more memory controllers 214 indicating an appropriate memory controller policy in line with the TDP level signals B being received by QoS controller 204.

Each QoS policy 225 may comprise a bandwidth shaping policy or throttle level for each shaper/throttle 206. A bandwidth shaping policy or throttle level is a value that a shaper/throttle 206 will not allow a particular UDM or Non-UDM element to exceed. The bandwidth throttle value may be characterized as a maximum threshold. However, it is possible in other exemplary embodiments that the bandwidth throttle value may also serve as a minimum value or threshold. In other embodiments, a shaper/throttle 206 could be assigned both minimum bandwidth as well as a maximum bandwidth as understood by one of ordinary skill in the art.

Each QoS Policy 225 maintained by the QoS controller 204 may be derived by one or more formulas or look-up tables which may map a number of active TDP level signals B and the TDP level (value) B of each signal at a given system frequency to the bandwidth throttle level for each core 222.

The QoS controller 204 may continuously convey the bandwidth shaping/throttling level that is part of each UDM and Non-UDM policy 225 to respective traffic shapers or traffic throttles 206 since these bandwidth levels may often change in value due to shifts TDP level values and/or frequency. As noted previously, bandwidths of Non-UDM elements 222b, such as Non-UDM cores 222b1-b4 of FIG. 1 may be shaped/throttled since each Non-UDM element may have an assigned throttle 206 similar to each UDM element 222a. While in some operating conditions, a Non-UDM Core 222b may be an aggressor core relative to one or more UDM cores 222a, it is also possible for a UDM core 222a to be an aggressor relative to other UDM cores 222a. In all instances, the QoS controller 204 via the QoS policy 225 derived for each core 222 may adjust the bandwidth throttle level of an aggressor core 222a1 or 222b1 via a respective throttle 206 in order to meet or achieve one or more downtime requests from one or more downtime requesting devices, such as memory controllers 214 and external downtime requesters 229.

For example, a UDM core 222a for the display controller 128 (See FIG. 8) may be the aggressor with respect to bandwidth consumption relative to a UDM core 222a for the camera 148 under certain operating conditions. This means the QoS controller 204, according to a QoS policy 225 assigned to the UDM core 222a for the display controller 128 may throttle the bandwidth of the display via a throttle/shaper 206 in order to give the UDM core 222a for the camera 148 more bandwidth as appropriate for specific operating conditions of the PCD 100 and for achieving certain downtime period request(s).

Referring now to FIG. 4, this figure is one exemplary embodiment of a downtime mapping table 400 as referenced in the QoS controller 204 illustrated in FIG. 1. The downtime mapping table 400 may be stored within internal memory (not illustrated) within the QoS Controller 204, such as in cache type memory. Alternatively, or additionally, the downtime mapping table 400 could be stored in memory 112 that is accessible by the QoS Controller 204.

Each row 402 in the downtime mapping table 400 may comprise an identity of the downtime requester (column 405) and the identity of each UDM element 222a (second column 407A, third column 407B, etc.) that may be impacted by the downtime requester. For example, in the first row 402, first column 407A, a value of “x” in the column 407 represents that the TDP time of the UDM must be considered when granting the downtime request from Downtime requester in row 402. Upon receipt of a down time requested downtime period (“RDP”) from a Downtime requester, it checks the row 402 in table 400 that correspond to the downtime requester. For each “x” in that row 402, the QOS controller ensures that the corresponding UDM element for the column that the “x” is marked is able to withstand the TDP time requested by the downtime requester. If all UDM elements with “x” in the corresponding row are able to withstand the requested downtime, then the QOS Controller 204 can grant the downtime request.

Referring now to FIG. 5, this figure is another exemplary embodiment of a downtime mapping table 500 for managing downtime requests from one or more downtime requesting elements, such as memory controllers 214. Downtime mapping table 500 is very similar to the downtime mapping table 400. Therefore, only the differences between these two tables will be described.

According to this table 500, one or more downtime requesting elements may be synchronized and therefore, any downtime request from a member of a group will be treated as a request from the group rather than from an individual downtime requesting element. For example, the first three downtime requesting elements listed in the first column 405 may be treated as a group, such as indicated by “Group A” listed in the second column 409 of table 500.

The QoS controller 204 may use this table 500 to determine which group of downtime requesting elements of system 101 are synchronized, such as a group of memory controllers 214. The remaining information of table 500 listed in the third, fourth and remaining columns 407A, 407B may function similarly to columns 407A, 407B of table 400 discussed above. Once a QoS controller 204 decides to grant a downtime request, such grants from the QOS Controller 204 are usually transmitted to all requesters in the group.

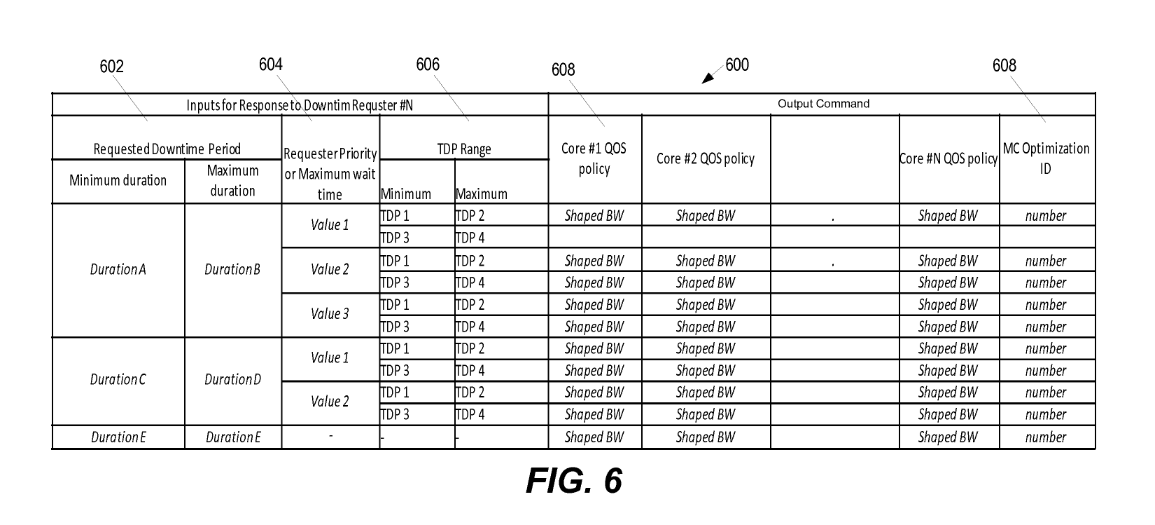

Referring now to FIG. 6, this figure is a an exemplary embodiment of a QoS policy mapping table 600 for managing downtime requests from one or more downtime requesting elements by throttling one or more UDM elements 222a and/or Non-UDM elements 222b. QOS controller 204 may have several instances of Table 600, each corresponding to one downtime requester or to a group of requesters as shown in Table 500. Table 600 may be used by the QoS controller 204 to reduce bandwidth of non-UDM cores 222b (or to other UDM 222a cores that have sufficiently high TDP) by action of shaper/throttle 206 and/or by changing one more QoS memory controller policies.

The QoS controller 204 may compute the minimum TDP from all impacted UDM cores 222a and may use that data as input to table 600 to determine the QoS policy (throttle bandwidth) and the memory controller optimization QoS policies to apply until all UDM elements 222a, 222b can meet the RDP (or adjusted RDP).

For example, when QOS Controller 204 receives a downtime request (“RDP”) from a downtime requester, it first consults table 400 or 500 to determine if the downtime request can be granted. If the downtime request cannot be granted because one or more UDM element is unable to withstand the downtime (TDP is less than the RDP), then the QOS controller locates the corresponding QoS policy mapping table 600 for the Downtime requester and uses the requested RDP to identify the corresponding row. This is done by successively selecting a subgroup of rows in Table 600 until a single row is identified. QOS controller 204 starts by examining the entries in column 602 to find a row, or set of rows, for which the RDP is more than the “Minimum Duration” entry but smaller than or equal to the “Maximum duration” entry. Once that row, or set of rows, is identified, the QOS controller examines the entries in column 604 that correspond to the requested RDP. Entries in column 604 represent Priority, Maximum urgency or maximum wait time of the RDP as indicated by the downtime requester.

QOS Controller 204 selects the row, or set of rows, that correspond to the indicated level Priority, Maximum urgency or maximum wait time of the RDP as indicated by the downtime requester. The QOS controller then moves to column 608 where it narrows down the row selection by comparing the value minimum value of TDP that the corresponding UDM cores can withstand to the “Minimum” and “Maximum” values in column 606 to arrive at a final single row in table 600. The “Output Command” columns in table 600 represent the Core and MC QOS policies that the QOS controller applies to the system until the UDM cores achieve a TDP that is equal to or larger than the RDP. The QOS policies in columns 608 represent the traffic shaping/throttling bandwidth that the QOS Controller applies to the throttle/shaper blocks 206 until the TDP of impacted UPMs is less than or equal to the RDP. Similarly the entry in column 608 indicate the memory controller QOS optimization policies that the QOS controller transmits to the memory controllers to provide more priority to UDM cores thus allowing them to reach the required TDP value.

During an RDP, if the minimum TDP range increases in response to a new downtime request with higher RDP (602) or an increased downtime request priority (604), the QOS controller 204 may choose a different row in the table 600 to account for a new mechanism. Table 600 may be used or can be replaced with a formula for each of the outputs using coefficients that are multiplied by the inputs to produce the outputs as understood by one of ordinary skill in the art.

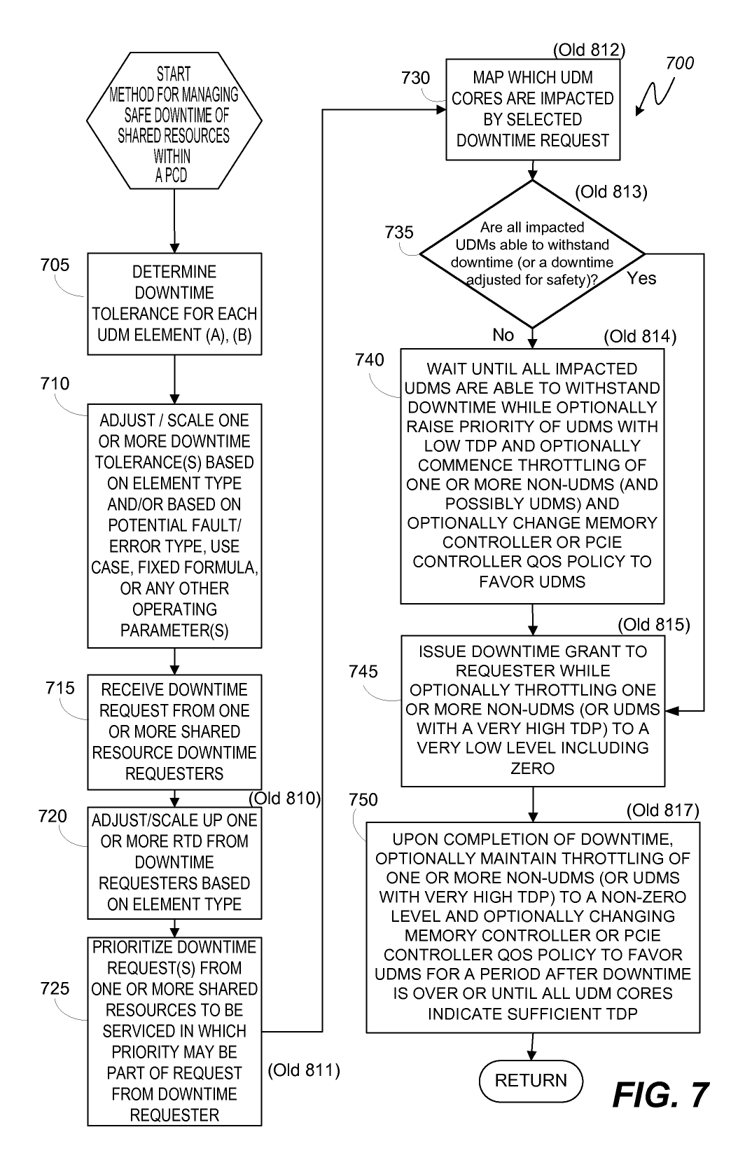

Referring now to FIG. 7, this figure is a logical flowchart illustrating an exemplary method 700 for managing safe downtime of shared resources within a portable computing device (“PCD”) 100. When any of the logic of FIG. 7 used by the PCD 100 is implemented in software, it should be noted that such logic may be stored on any tangible computer-readable medium for use by or in connection with any computer-related system or method. In the context of this document, a tangible computer-readable medium is an electronic, magnetic, optical, or other physical device or means that may contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that may fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device.

The computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include, but are not limited to, the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

Referring back to FIG. 7, block 705 is the first step of method 700. In block 705, the TDP sensors A found in each UDM element 222a and as illustrated in detail in FIGS. 2-3 may determine the downtime tolerance for its respective UDM element 222a. TDP may comprise the “raw” time for a UDM element 222a as described above multiplied by a factor for additional safety. This means a TDP calculator 306 may determine the “raw” time that can be tolerated by a UDM element 222a and multiply it by the factor of safety which becomes the TDP level or value B as illustrated in FIG. 2.

Alternatively, Tolerable Downtime Period (“TDP”) Levels determined by each TDP calculator 306b of FIG. 3 may comprise a set of numbers (0, 1, 2, 3 . . . N) that each indicates to the QoS Controller 204 that this UDM element 222a can tolerate a pre-determined amount of time that is proportional to FIFO fill levels. If a UDM element 222a is sensitive to multiple downtime requesters, the UDM element 222a via the TDP calculator 306b either computes a TDP or TDP Level B that represents the minimum downtime tolerance for all downtime requestors OR it may send different TDP/TDP Level signals B, each corresponding to a different downtime requester.

Next, in block 710, the QoS controller 204 may adjust or scale one or more downtime tolerances sent as TDP signals B based on the UDM element type and/or based on potential fault/error type, a use case, a fixed formula, or any other operating parameter. In block 715, one or more downtime requests may be received along data line 212′ (212-“prime”) from one or more shared resources, like memory controllers 214 located “on-chip” 102 as well as from external sources located “off-chip”, such as external downtime requester(s) 229.

In block 720, for each arriving request for downtime received along data line 212′, the QOS Controller 204, may optionally adjust/scale the downtime request to add in a safety margin by increasing a value for the received RDP. In block 725, the QoS controller 204 may prioritize downtime request(s) to be serviced from one or more shared resources, such as memory controllers 214 based on any priority data which is contained within the downtime request. In this block 725, if multiple downtime requests arrive simultaneously at the QoS controller 204 along data line 212′ from unrelated requesters (not groups), the QOS controller 204 may first prioritize the requests based on: (a) priority of the request based on the priority flag that may be part of the downtime request; (b) priority of the request where priority in the downtime request may indicate the relative importance of the downtime requesting device; and/or (c) a priority of the request may also indicate a maximum time that the downtime requesting device may wait before it has to enter into downtime: downtime requesting devices with an earlier maximum wait time can be given priority over downtime requesting devices with a longer maximum wait time.

In block 730, the QoS controller 204 may map which UDM elements 222a may be impacted by each downtime request using table 400 or 500. Using Table 400 or 500 the QOS controller is able to determine which cores are impacted by the downtime requester. The QOS controller 204 then collects the TDP values of all impacted UDMs and uses it in block 735 to determine if the requested RDP can be granted. Next, in decision block 735, the QoS controller 204 determines if the TDP of each impacted UDM element 222a, such as each UDM core 222a1-222a4, is such that the UDM cores are able to withstand the selected downtime duration. In other words, in this decision block 735, the QoS controller 204 may determine if each QOS controller internally adjusted TDP of each UDM element 222 is greater than or equal to the QoS controller internally adjusted RDP for a given UDM element 222.

If the inquiry to decision block 735 is negative in which at least one UDM element 222a cannot function for the duration of the selected downtime request, then the “NO” branch is followed to block 740. In block 740, the QoS controller 204 may wait until all impacted UDM elements 222a are able to withstand/tolerate the selected downtime request. During this wait time, the QoS controller 204 may raise priority of other UDM elements with low TDP. Also, the QoS controller 204 may also optionally commence throttling of one or more non-UDM elements 222b (and possibly UDM elements 222a). Additionally, the QoS controller in this block 740 may also change a memory controller policy and/or PCIE controller QoS policy to favor one or more UDM elements 222a.

In other words, in this block 740, in addition to just waiting until all UDM elements 222a may withstand a duration/magnitude of a requested downtime request, the QoS controller 204 may change the conditions of system 101 to accelerate the elevation of the TDP of affected UDM elements 222a. One of three FOUR techniques (mentioned briefly above) or a combination thereof may be employed by the QoS controller 204 to elevate TDP of affected UDM element 222a: TDP Elevation technique #1: The QoS controller 2014 may increase priority of traffic from UDM elements 222a with insufficient TDP and/or decrease priority of non-UDM elements 222b or UDM elements 222a with very high TDP.

TDP Elevation technique #2: the QoS controller 204 may reduce bandwidth of non-UDM elements 222b (or to other UDM elements 222a that have sufficiently high TDP) with throttle/bandwidth shaping elements 206.

TDP Elevation technique #3: the QoS may change the QoS policy of a memory controller 214 or the PCI-Express controller 199 (or any other shared resource controller) to provide more bandwidth to the UDM cores 222a that cannot survive/function within the requested downtime period. These three techniques can be applied at the same time or can be applied in sequence in time as the maximum wait time of downtime requesting elements increase.

TDP Elevation technique #4: the QoS may increase the frequency of the interconnect or any other traffic carrying element in the system 100 that may provide increased bandwidth to the UDM cores without requiring a downtime for that frequency increase

For TDP elevation technique #1: the QoS controller 204 may increase priority of traffic from UDM cores 222. With this technique, the QoS controller 204 may instructs the throttle-shaper 206 of each UDM element 222a with insufficiently high TDP to increase the priority of the traffic flowing through it by raising priority of each transactions that flow through it or by signaling to the throttle-shaper 206 of one or more non-UDM element 222b to decrease the priority of the traffic flowing through it by reducing the priority of each transaction that flows through it.

For TDP elevation techniques #2-3, the QoS controller 204 may reduce bandwidth of non-UDM cores 222b (or to other UDM cores 222a that have sufficiently high TDP) by action of issuing commands to shaper/throttles 206 and/or by changing QoS memory controller policies. Under TDP elevation techniques #2-3, the QoS controller may using table 600 discussed above. The QoS controller may compute the minimum TDP from all impacted UDM cores 222a and uses that as input to table 600 of FIG. 6 to determine the QoS policy (throttle Bandwidth) and the memory controller optimization QoS policy to apply until all UDM elements 222a may meet the RDP (or adjusted RDP).

During this wait period of block 740, as the minimum TDP range increases for each UDM element 222a in response to one of the TDP elevation techniques described above, the QoS controller 204 may choose a different row in the table 600 of FIG. 6 to account for the most recent elevation technique selected. Table 600 of FIG. 6 may be used by QoS controller 204 or it can be replaced with a formula for each of the outputs using coefficients that are multiplied by the inputs to produce the outputs as understood by one of ordinary skill in the art.

In block 745, the selected downtime request is issued to the downtime requesting element by the QoS controller 204 to initiate downtime. During this downtime period, the QoS controller 204 may optionally remove the QoS policy that it enforced on traffic shapers 206 and memory controllers 214. Alternatively, or additionally, the QoS controller 204 may maintain the QoS policy that it enforced on traffic shapers 206 and memory controllers 214. Alternatively, the QoS controller 204 may apply a different QoS policy on traffic shapers 206 and memory controllers 214 for duration of the downtime. As another alternative, the QoS controller 204 may maintain old QOS policy or applying a different QOS policy that may prevent non-UDM elements 222b from issuing many transactions/requests to the system 101 during the granted downtime, thus causing a loss of bandwidth to the UDM cores once downtime is completed.

In block 750, once the granted downtime request is completed, QoS controller 204 may cease to apply a QoS policy that it enforced on traffic shapers 206 and memory controllers 214 OR it may choose to maintain the QoS policy that it enforced on traffic shapers 206 and memory controllers 214 (or modify that policy) to ensure that UDM elements 222a recover from the granted downtime period.

The duration of the optional period of QoS policy enforcement post-downtime may comprise any one of the following: (a) a fixed value/length of time; (b) a fixed value/length of time proportional to the granted downtime period; and (c) a variable value/length of time. For example, this variable length of time may be tied/associated with until all UDM elements 222a have a new TDP that is higher than a predefined value. After block 750, the method 700 then may return to the beginning.

In a particular aspect, one or more of the method steps described herein, such as, but not limited to, those illustrated in FIG. 7, may be implemented by executable instructions and parameters stored in the memory 112. These instructions may be executed by the QoS controller 204, traffic shapers or traffic throttles 206, frequency controller 202, memory controller 214, CPU 110, the analog signal processor 126, or another processor, in addition to the ADC controller 103 to perform the methods described herein. Further, the controllers 202, 204, 214, the traffic shapers/throttles 206, the processors 110, 126, the memory 112, the instructions stored therein, or a combination thereof may serve as a means for performing one or more of the method steps described herein.

Referring now to FIG. 8, this figure is a functional block diagram of an exemplary, non-limiting aspect of a PCD 100 in the form of a wireless telephone for implementing methods and systems managing downtime requests based on TDP level signals B monitored from one or more UDM elements 222a. As shown, the PCD 100 includes an on-chip system 102 that includes a multi-core central processing unit (“CPU”) 110 and an analog signal processor 126 that are coupled together. The CPU 110 may comprise a zeroth core 222a, a first core 222b1, and an Nth core 222bn as understood by one of ordinary skill in the art.

As discussed above, cores 222a having the small letter “a” designation comprise unacceptable deadline miss (“UDM”) cores. Meanwhile, cores 222b having a small letter “b” designation comprise Non-UDM cores as described above.

Instead of a CPU 110, a second digital signal processor (“DSP”) may also be employed as understood by one of ordinary skill in the art. The PCD 100 has a quality of service (“QoS”) controller 204 and a frequency controller 202 as described above in connection with FIG. 1.

In general, the QoS controller 204 is responsible for bandwidth throttling based on TDP signals B monitored from one or more hardware elements, such as the CPU 110 having cores 222a,b and the analog signal processor 126. As described above, the QoS controller 204 may issue commands to one or more traffic shapers or traffic throttles 206, the frequency controller 202, and one or more memory controllers 214A, B. The memory controllers 214A, B may manage and control memory 112A, 112B. A first memory 112A may be located on-chip, on SOC 102, while a second memory 112B may be located off-chip, not on/within the SOC 102, such as illustrated in FIG. 1.

Each memory 112 may comprise volatile and/or non-volatile memory that resides inside SOC or outside SOC as described above. Memory 112 may include, but is not limited to, dynamic random access memory (“DRAM”), Internal static random access memory (“SRAM”) memory (“IMEM”), or a Peripheral Component Interconnect Express (“PCI-e”) external transport link. The memory 112 may comprise flash memory or a solid-state memory device. Although depicted as a single device, the memory 112 may be a distributed memory device with separate data stores coupled to the CPU 110, analog signal processor 126, and QoS controller 204.

The external, off-chip memory 112B may be coupled to a PCI peripheral port 198. The PCI peripheral port 198 may be coupled to and controlled by a PCI controller 199 which may reside on-chip, on the SOC 102. The PCI controller 199 may be coupled to one or more PCI peripherals through a Peripheral Component Interconnect Express (“PCI-e”) external transport link through the PCI peripheral port 198.

As illustrated in FIG. 8, a display controller 128 and a touch screen controller 130 are coupled to the CPU 110. A touch screen display 132 external to the on-chip system 102 is coupled to the display controller 128 and the touch screen controller 130. The display 132 and display controller may work in conjunction with a graphical processing unit (“GPU”) 182 for rendering graphics on display 132.

PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 8, a universal serial bus (“USB”) controller 140 is coupled to the CPU 110. Also, a USB port 142 is coupled to the USB controller 140.

Further, as shown in FIG. 8, a digital camera 148 may be coupled to the CPU 110, and specifically to a UDM core 222a, such as UDM core 222a of FIG. 1. In an exemplary aspect, the digital camera 148 is a charge-coupled device (“CCD”) camera or a complementary metal-oxide semiconductor (“CMOS”) camera.

As further illustrated in FIG. 8, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 8 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 8 further indicates that a radio frequency (“RF”) transceiver 168 may be coupled to the analog signal processor 126. An RF switch 170 may be coupled to the RF transceiver 168 and an RF antenna 172. As shown in FIG. 8, a keypad 174 may be coupled to the analog signal processor 126. Also, a mono headset with a microphone 176 may be coupled to the analog signal processor 126. Further, a vibrator device 178 may be coupled to the analog signal processor 126.

FIG. 8 also shows that a power supply 188, for example a battery, is coupled to the on-chip system 102 through a power management integrated circuit (“PMIC”) 180. In a particular aspect, the power supply 188 may include a rechargeable DC battery or a DC power supply that is derived from an alternating current (“AC”) to DC transformer that is connected to an AC power source. Power from the PMIC 180 is provided to the chip 102 via a voltage regulator 189 with which may be associated a peak current threshold.

The CPU 110 may also be coupled to one or more internal, on-chip thermal sensors 157A as well as one or more external, off-chip thermal sensors 157B-C. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B-C may comprise one or more thermistors. The thermal sensors 157B-C may produce a voltage drop that is converted to digital signals with an analog-to-digital converter (“ADC”) controller 103. However, other types of thermal sensors may be employed without departing from the scope of this disclosure.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157B-C are external to the on-chip system 102.

The CPU 110, as noted above, is a multiple-core processor having N core processors 222. That is, the CPU 110 includes a zeroth core 222a, a first core 222b1, and an N^{th} core 222bn. As is known to one of ordinary skill in the art, each of the first zeroth core 222a, the first core 222b and the N^{th} core 222bn are available for supporting a dedicated application or program. Alternatively, one or more applications or programs may be distributed for processing across two or more of the available cores 222.

The zeroth core 222a, the first core 222b and the N^{th} core 222bn of the CPU 110 may be integrated on a single integrated circuit die, or they may be integrated or coupled on separate dies in a multiple-circuit package. Designers may couple the zeroth core 222a, the first core 222b and the N^{th} core 222bn via one or more shared caches (not illustrated) and they may implement message or instruction passing via network topologies such as bus, ring, mesh and crossbar topologies.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

The various operations and/or methods described above may be performed by various hardware and/or software component(s) and/or module(s), and such component(s) and/or module(s) may provide the means to perform such operations and/or methods. Generally, where there are methods illustrated in Figures having corresponding counterpart means-plus-function Figures, the operation blocks correspond to means-plus-function blocks with similar numbering. For example, blocks 705 through 750 illustrated in FIG. 7 correspond to means-plus-functions that may be recited in the claims.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

The methods or systems, or portions of the system and methods, may be implemented in hardware or software. If implemented in hardware, the devices can include any, or a combination of, the following technologies, which are all well known in the art: discrete electronic components, an integrated circuit, an application-specific integrated circuit having appropriately configured semiconductor devices and resistive elements, etc. Any of these hardware devices, whether acting or alone, with other devices, or other components such as a memory may also form or comprise components or means for performing various operations or steps of the disclosed methods.

The software and data used in representing various elements can be stored in a memory and executed by a suitable instruction execution system (microprocessor). The software may comprise an ordered listing of executable instructions for implementing logical functions, and can be embodied in any “processor-readable medium” for use by or in connection with an instruction execution system, apparatus, or device, such as a single or multiple-core processor or processor-containing system. Such systems will generally access the instructions from the instruction execution system, apparatus, or device and execute the instructions.

Therefore, although selected aspects have been illustrated and described in detail, it will be understood that various substitutions and alterations may be made therein without departing from the spirit and scope of the present invention, as defined by the following claims.

What is claimed is:

1. A method for managing safe downtime of shared resources within a portable computing device, the method comprising:
determining a tolerance for a downtime period for an unacceptable deadline miss element of the portable computing device;
transmitting the tolerance for the downtime period to a central location within the portable computing device;
determining if the tolerance for the downtime period needs to be adjusted;
receiving a downtime request from one or more shared resources of the portable computing device;
determining if the downtime request needs to be adjusted;
selecting a downtime request for execution;
identifying which one or more unacceptable deadline miss elements of the portable computing device that are impacted by the selected downtime request;
determining if impacted unacceptable deadline miss elements may function properly for a duration of the selected downtime request; and
if the impacted unacceptable deadline miss elements may function properly during the duration of the selected downtime request, then granting the downtime request to one or more devices which requested the selected downtime request.

2. The method of claim 1, further comprising if the impacted one or more unacceptable deadline miss elements may not function properly during the duration of the selected downtime request, then not issuing the downtime request until all unacceptable deadline miss elements may function properly for the duration of the selected downtime request.

3. The method of claim 2, further comprising raising a priority of one or more unacceptable deadline miss elements with a predetermined tolerable downtime period.

4. The method of claim 2, further comprising issuing a command to adjust bandwidth of at least one of an unacceptable deadline miss element and non-unacceptable deadline miss element.

5. The method of claim 2, further comprising throttling a bandwidth for one or more unacceptable deadline miss elements.

6. The method of claim 2, further comprising changing a policy of at least one of a memory controller and a Peripheral Component Interconnect Express (“PCI-e”) controller to favor an unacceptable deadline element.

7. The method of claim 1, wherein an unacceptable deadline element comprises at least one of a processing core, a display engine, a camera controller, a graphical processing unit, a modem, and software or firmware running on a programmable computing engine.

8. The method of claim 1, wherein identifying which one or more unacceptable deadline miss elements of the portable computing device are impacted by the selected downtime request further comprises generating a mapping table that maps downtime requesting devices with one or more unacceptable deadline miss elements.

9. The method of claim 1, throttling one or more non-unacceptable deadline elements after the downtime request period is completed.

10. The method of claim 1, wherein the portable computing device comprises at least one of a mobile telephone, a personal digital assistant, a pager, a smartphone, a navigation device, and a hand-held computer with a wireless connection or link.

11. A system for managing safe downtime of shared resources within a portable computing device, the system comprising:
a processor operable for:
determining a tolerance for a downtime period for an unacceptable deadline miss element of the portable computing device;
transmitting the tolerance for the downtime period to a central location within the portable computing device;
determining if the tolerance for the downtime period needs to be adjusted;
receiving a downtime request from one or more shared resources of the portable computing device;
determining if the downtime request needs to be adjusted;
selecting a downtime request for execution;
identifying which one or more unacceptable deadline miss elements of the portable computing device that are impacted by the selected downtime request;
determining if impacted unacceptable deadline miss elements may function properly for a duration of the selected downtime request; and
if the impacted unacceptable deadline miss elements may function properly during the duration of the selected downtime request, then granting the downtime request to one or more devices which requested the selected downtime request.

12. The system of claim 11, wherein the processor is further operable for not issuing the downtime request until all unacceptable deadline miss elements function properly for the duration of the selected downtime request if anyone of unacceptable deadline miss elements do not function properly during the duration of the selected downtime request.

13. The system of claim 11, wherein the processor is further operable for raising a priority of one or more unacceptable deadline miss elements with a predetermined tolerable downtime period.

14. The system of claim 11, wherein the processor is further operable for issuing a command to adjust bandwidth of at least one of an unacceptable deadline miss element and non-unacceptable deadline miss element.

15. The system of claim 11, wherein the processor is further operable for throttling a bandwidth for one or more unacceptable deadline miss elements.

16. The system of claim 11, wherein the processor is further operable for changing a policy of at least one of a memory controller and a Peripheral Component Interconnect Express (“PCI-e”) controller to favor an unacceptable deadline element.

17. The system of claim 11, wherein an unacceptable deadline element comprises at least one of a processing core, a display engine, a camera controller, a graphical processing unit, a modem, and software or firmware running on a programmable computing engine.

18. The system of claim 11, wherein the processor identifying which one or more unacceptable deadline miss elements of the portable computing device are impacted by the selected downtime request further comprises the processor generating a mapping table that maps downtime requesting devices with one or more unacceptable deadline miss elements.

19. The system of claim 11, wherein the processor is further operable for throttling one or more non-unacceptable deadline elements after the downtime request period is completed.

20. The system of claim 11, wherein the portable computing device comprises at least one of a mobile telephone, a personal digital assistant, a pager, a smartphone, a navigation device, and a hand-held computer with a wireless connection or link.

21. A system for managing safe downtime of shared resources within a portable computing device, the system comprising:
means for determining a tolerance for a downtime period for an unacceptable deadline miss element of the portable computing device;
means for transmitting the tolerance for the downtime period to a central location within the portable computing device;
means for determining if the tolerance for the downtime period needs to be adjusted;
means for receiving a downtime request from one or more shared resources of the portable computing device;
means for determining if the downtime request needs to be adjusted;
means for selecting a downtime request for execution;
means for identifying which one or more unacceptable deadline miss elements of the portable computing device that are impacted by the selected downtime request;
means for determining if impacted unacceptable deadline miss elements may function properly for a duration of the selected downtime request; and
means for granting the downtime request to one or more devices which requested the selected downtime request if the impacted unacceptable deadline miss elements may function properly during the duration of the selected downtime request.

22. The system of claim 21, further comprising means for not issuing the downtime request until all unacceptable deadline miss elements function properly for the duration of the selected downtime request if anyone of unacceptable deadline miss elements do not function properly during the duration of the selected downtime request.

23. The system of claim 21, further comprising means for raising a priority of one or more unacceptable deadline miss elements with a predetermined tolerable downtime period.

24. The system of claim 21, further comprising means for issuing a command to adjust bandwidth of at least one of an unacceptable deadline miss element and non-unacceptable deadline miss element.

25. The system of claim 21, further comprising means for throttling a bandwidth for one or more unacceptable deadline miss elements.

26. A system for managing safe downtime of shared resources within a portable computing device, the system comprising:
a processor operable for determining a tolerance for a downtime period for an unacceptable deadline miss element of the portable computing device;
a processor operable for transmitting the tolerance for the downtime period to a central location within the portable computing device;
a processor operable for determining if the tolerance for the downtime period needs to be adjusted;
a processor operable for receiving a downtime request from one or more shared resources of the portable computing device;
a processor operable for determining if the downtime request needs to be adjusted;
a processor operable for selecting a downtime request for execution;
a processor operable for identifying which one or more unacceptable deadline miss elements of the portable computing device that are impacted by the selected downtime request;
a processor operable for determining if impacted unacceptable deadline miss elements may function properly for a duration of the selected downtime request; and
a processor operable for granting the downtime request to one or more devices which requested the selected downtime request if the impacted unacceptable deadline miss elements may function properly during the duration of the selected downtime request, wherein an unacceptable deadline element comprises at least one of a processing core, a display engine, a camera controller, a graphical processing unit, a modem, and software or firmware running on a programmable computing engine.

27. The system of claim 26, further comprising a processor for not issuing the downtime request until all unacceptable deadline miss elements function properly for the duration of the selected downtime request if anyone of unacceptable deadline miss elements do not function properly during the duration of the selected downtime request.

28. The system of claim 26, further comprising a processor for raising a priority of one or more unacceptable deadline miss elements with a predetermined tolerable downtime period.

29. The system of claim 26, further comprising a processor for issuing a command to adjust bandwidth of at least one of an unacceptable deadline miss element and non-unacceptable deadline miss element.

30. The system of claim 26, further comprising a processor for throttling a bandwidth for one or more unacceptable deadline miss elements.
